(19) United States
(12) Patent Application Publication
(10) Pub. No.: US 2018/0150794 A1
(43) Pub. Date: May 31, 2018

(54) CARGO DELIVERY SCHEDULING METHOD, DEVICE AND NON-TRANSITORY COMPUTER READABLE MEDIUM OF THE SAME

(71) Applicant: INSTITUTE FOR INFORMATION INDUSTRY, Taipei (TW)

(72) Inventors: Pao-Chung HO, Taipei City (TW); Austin Cheng-Yun TSAI, Hsinchu City (TW); Frank Chee-Da TSAI, Taipei City (TW)

(21) Appl. No.: 15/371,173

(22) Filed: Dec. 6, 2016

(30) Foreign Application Priority Data
Nov. 30, 2016 (TW) 105139547

(51) Int. Cl. G06Q 10/08

(52) U.S. Cl. CPC G06Q 10/0833; G06Q 10/08355

(57) ABSTRACT

A cargo delivery scheduling method that includes the steps outlined below is provided. (A) Cargo-shipping data is received each including an available shipping time period and a shipping address that includes a fixed geographical shipping area and instant positioning information. (B) The cargo-shipping data that matches a delivery time period are retrieved. (C) A delivery geographical shipping area is determined as the fixed geographical shipping area comprised in most number of the cargo-shipping-location data. (D) Real-time locations are retrieved according to the real-time locating information. (E) A cargo delivery path is determined according to the real-time locations. (F) Whether the cargo is delivered is determined and cargo-shipping-location data corresponding to cargo finished delivering are removed. (G) When the delivery time period is finished, steps (B) to (G) are performed for a next delivery time period according to the remained pieces of cargo-shipping-location data.

### RELATED APPLICATIONS

This application claims priority to Taiwan Application Serial Number 105139547, filed Nov. 30, 2016, which is herein incorporated by reference.

### BACKGROUND

### Field of Invention

The present invention relates to a scheduling technology. More particularly, the present invention relates to a cargo delivery scheduling method, device, and non-transitory computer readable medium of the same.

### Description of Related Art

When a cargo is delivered, the most common issue is that the available time of the recipient and the delivery time of the delivery person are not matched, with the result that the delivery person can not deliver the cargo at the first attempt. Further, the delivery person may have to reschedule the delivery time with the recipient several times in order to successfully deliver the cargo. Often that case is that when the recipient is available, the delivery person happen to be delivering the cargos in other locations and can not perform the delivery on time for such a recipient. If there is no efficient scheduling method, not only the costs of the time and the fuel of the transportation of the delivery person increase, but the recipient may take longer time to wait for the delivery.

Accordingly, an innovative cargo delivery scheduling method, device, and non-transitory computer readable medium of the same to shall much mitigate the aforementioned issues.

### SUMMARY

The invention provides a cargo delivery scheduling method that includes the steps outlined below. (A) A plurality pieces of cargo-shipping data each comprising at least one available shipping time period and at least one shipping address corresponding to the available shipping time period of the recipient are received, wherein the shipping address comprises a fixed geographical shipping area and an identifier pointing to the recipient's instant positioning information. (B) For a delivery time period, the pieces of the cargo-shipping data having the available shipping time period matching the delivery time period are retrieved. (C) A statistical analysis is performed on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data. (D) A first instant position is retrieved according to the instant positioning information of each of the pieces of the cargo-shipping data that have the fixed geographical shipping area matching the delivery geographical shipping area. (E) A cargo delivery path is determined according to the first instant positions of the pieces of the cargo-shipping data. (F) Whether the cargo is delivered is determined and the pieces of the delivered cargo-shipping data are removed. (G) When the delivery time period ends, steps (B) to (G) are performed for the next delivery time period based on the remaining cargo-shipping data.

Another aspect of the present invention is to provide a cargo delivery scheduling device that includes an input unit, an instant positioning unit, a storage unit and a processing unit. The storage unit is configured to store an application program. The processing unit is electrically coupled to the input unit, the instant positioning unit and the storage unit and is configured to execute the application program to perform a cargo delivery scheduling method that includes the steps outlined below. (A) A plurality pieces of cargo-shipping data each comprising at least one available shipping time period and at least one shipping address corresponding to the available shipping time period of the recipient are received by using the input unit, wherein the shipping address comprises a fixed geographical shipping area and an identifier pointing to the recipient's instant positioning information. (B) For a delivery time period, the pieces of the cargo-shipping data having the available shipping time period matching the delivery time period are retrieved. (C) A statistical analysis is performed on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data. (D) A first instant position is retrieved by using the instant positioning unit according to the instant positioning information of each of the pieces of the cargo-shipping data that have the fixed geographical shipping area matching the delivery geographical shipping area. (E) A cargo delivery path is determined according to the first instant positions of the pieces of the cargo-shipping data. (F) Whether the cargo is delivered is determined and the pieces of the delivered cargo-shipping data are removed. (G) When the delivery time period ends, steps (B) to (G) are performed for the next delivery time period based on the remaining cargo-shipping data.

Yet another aspect of the present invention is to provide a non-transitory computer readable medium that stores an application program to execute a cargo delivery scheduling method used in a cargo delivery scheduling device. The cargo delivery scheduling method includes the steps outlined below. (A) A plurality pieces of cargo-shipping data each comprising at least one available shipping time period and at least one shipping address corresponding to the available shipping time period of the recipient are received, wherein the shipping address comprises a fixed geographical shipping area and an identifier pointing to the recipient's instant positioning information. (B) For a delivery time period, the pieces of the cargo-shipping data having the available shipping time period matching the delivery time period are retrieved. (C) A statistical analysis is performed on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data. (D) A first instant position is retrieved according to the instant positioning information of each of the pieces of the cargo-shipping data that have the fixed geographical shipping area matching the delivery geographical shipping area. (E) A cargo delivery path is determined according to the first instant positions of the pieces of the cargo-shipping data. (F) Whether the cargo is delivered is determined and the pieces of the delivered cargo-shipping data are removed. (G) When the delivery time period ends, steps (B) to (G) are performed for the next delivery time period based on the remaining cargo-shipping data.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a cargo delivery scheduling device in an embodiment of the present invention;

FIG. 2 is a flow chart of a cargo delivery scheduling method in an embodiment of the present invention;

FIG. 3 is diagram illustrating a plurality pieces of the cargo-shipping data in an embodiment of the present invention;

FIGS. 4A-4D are diagrams illustrating each of the delivery time periods, each of the fixed geographical shipping areas and the corresponding recipients in an embodiment of the present invention;

FIG. 5 is a diagram illustrating a plurality pieces of the cargo-shipping data in another embodiment of the present invention; and

FIGS. 6A-6D are diagrams illustrating each of the delivery time periods, each of the fixed geographical shipping areas, the corresponding recipients and the corresponding preference indexes in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

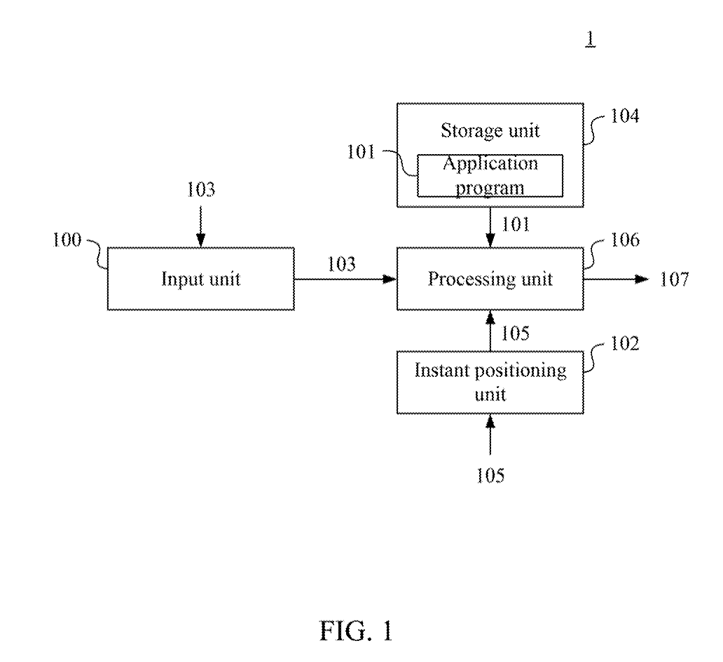

Reference is now made to FIG. 1. FIG. 1 is a block diagram of a cargo delivery scheduling device 1 in an embodiment of the present invention. The cargo delivery scheduling device 1 includes an input unit 100, an instant positioning unit 102, a storage unit 104 and a processing unit 106.

The input unit 100 can be such as, but not limited to a keyboard, a mouse, a touch panel, a network unit that can receiver or transmit data through a network, to perform data input and data output. The input unit 100 can also be a combination of the input and output elements described above.

The instant positioning unit 102 can perform positioning according to instant positioning information, such as but not limited to a global navigation satellite system (GNSS) identification code. The global navigation satellite system can be such as, but not limited to the global positioning system (GPS), the Galileo system, Compass system (Beidou) or the GLONASS system.

The storage unit 104 can be such as, but not limited to a system memory, a hard disk, a random access memory (RAM), a ROM (read-only memory), an electrically-erasable programmable read-Only memory (EEPROM), a compact disc read-only memory (CD-ROM), a digital versatile disc (DVD) or a flash memory. The storage unit 104 is configured to store an application program 101.

The processing unit 106 is electrically coupled to the input unit 100, the instant positioning unit 102 and the storage unit 104. The processing unit 106 is configured to access the data stored in the storage unit 104, such as but not limited to the application program 101 and executes the application program 101. Moreover, the processing unit 106 can control the operation of the input unit 100 and the instant positioning unit 102.

In a usage scenario, the cargo delivery scheduling device 1 is disposed in cargo delivery transportations such as, but not limited to a car, a trunk, a bicycle, or a handheld electronic device of the driver of thereof such that the function of the cargo delivery scheduling is accomplished by operating the cargo delivery scheduling device 1.

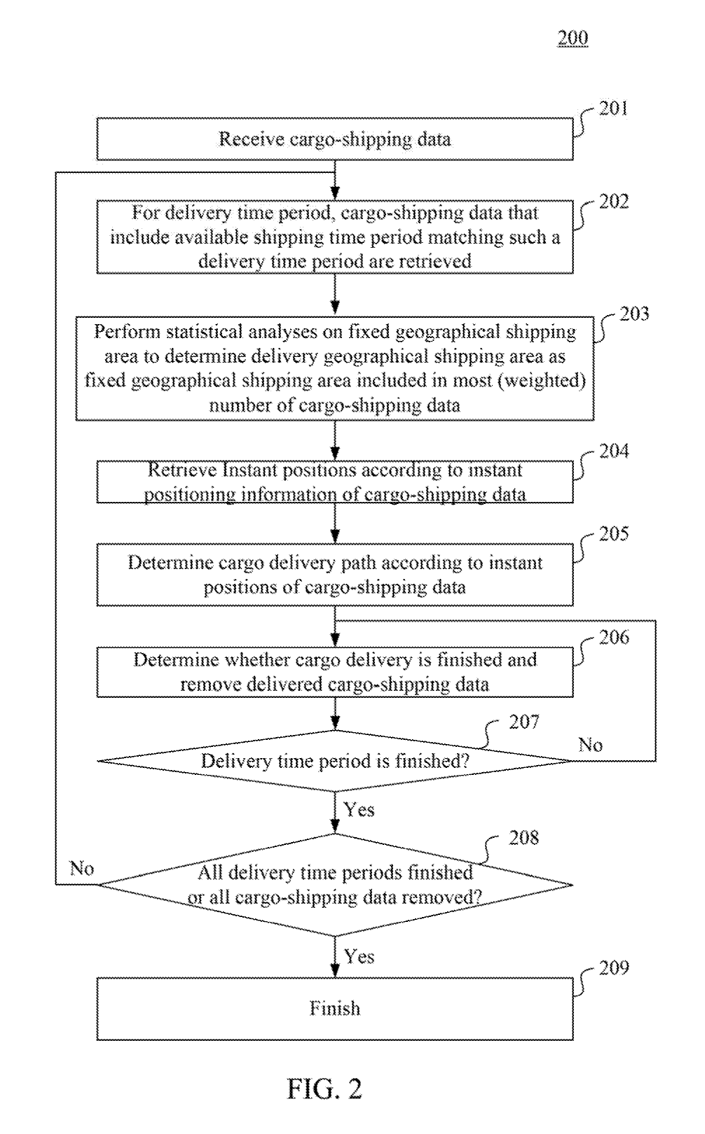

Reference is now made to FIG. 2 at the same time. FIG. 2 is a flow chart of a cargo delivery scheduling method 200 in an embodiment of the present invention. The cargo delivery scheduling method 200 can be used in the cargo delivery scheduling device 1 illustrated in FIG. 1, or be implemented by using other hardware components such as a common processor, a computer, a server, other unique hardware devices that have a specific logic circuit or an equipment having a specific function, e.g. a unique hardware integrated by a computer program and a processor or a chip. More specifically, the cargo delivery scheduling method 200 is implemented by using a computer program to control the modules in the cargo delivery scheduling device 1. The computer program can be stored in a non-transitory computer readable medium such as a ROM (read-only memory), a flash memory, a floppy disc, a hard disc, an optical disc, a flash disc, a tape, a database accessible from a network, or any storage medium with the same functionality that can be contemplated by persons of ordinary skill in the art to which this invention pertains.

In following paragraphs, the cargo delivery scheduling method 200 performed by the cargo delivery scheduling device 1 is described in detail accompanied with FIG. 1 and FIG. 2. The cargo delivery scheduling method 200 comprises the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, receiving a plurality pieces of cargo-shipping data 103 by using the input unit 100. As described above, the input unit 100 can be such as, but not limited to a keyboard, a mouse, a touch panel, a network unit that can receiver or transmit data through a network or a combination of the input and output elements described above to perform data input and data output. As a result, the cargo-shipping data 103 can be received by a direct input from a keyboard, a mouse or a touch panel, or by a network unit through a network.

Each piece of the cargo-shipping data 103 includes at least one available shipping time period and at least one shipping address corresponding to the available shipping time period of the recipient. A unit of the available shipping time period can be such as, but not limited to one hour. In other embodiments, other time lengths can be used as the unit of the available shipping time period.

The shipping address may include such as, but not limited to a fixed geographical shipping area and an identifier pointing to the recipient's instant positioning information. In an embodiment, the fixed geographical shipping area is generated by mapping an address provided by the recipient to a default geographical shipping area, such as but not limited to an administrative area. For example, when the address provided by the recipient is “No. 100, Sec. 2, Zhongxiao E. Rd., Taipei City”, the fixed geographical shipping area is generated by mapping the address to the “Zhongzheng district”. The instant positioning information can be such as, but not limited to the global navigation satellite system identification code of the handheld electronic device of the recipient.

As a result, the fixed geographical shipping area of the shipping address provides the location of the recipient in a larger range of region within a specific time period. The instant positioning information of the shipping address provides the precise and instant location of the recipient.

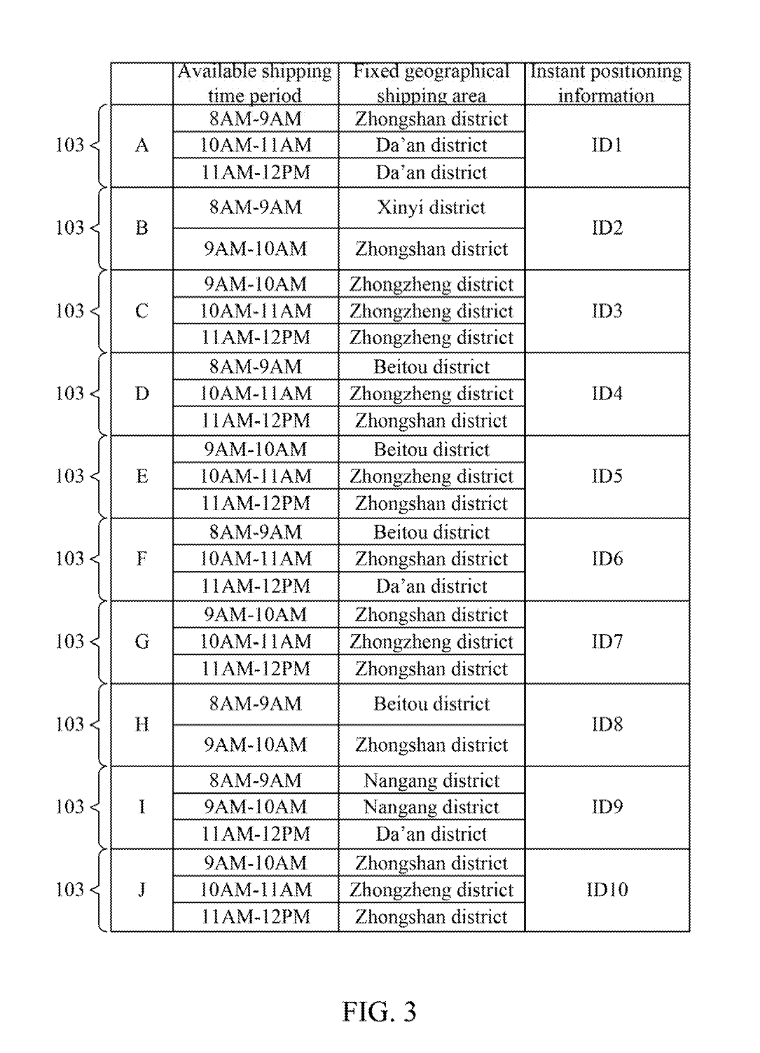

Reference is now made to FIG. 3. FIG. 3 is a diagram illustrating a plurality of pieces of the cargo-shipping data 103 in an embodiment of the present invention.

In FIG. 3, ten pieces of the cargo-shipping data 103 corresponding to ten recipients A-J are illustrated as entries of a table. The available shipping time periods of the recipient A are 8-9 AM, 10-11 AM and 11-12 AM corresponding to the fixed geographical shipping areas of Zhongshan district, Da'an district and Da'an district respectively. The available shipping time periods of the recipient B are 8-9 AM and 9-10 AM corresponding to the fixed geographical shipping areas of Xinyi district and Zhongshan district respectively. The available shipping time periods of the recipient C are 9-10 AM, 10-11 AM and 11-12 AM corresponding to the fixed geographical shipping areas of Zhongzheng district, Zhongzheng district and Zhongzheng district respectively. The available shipping time periods of the recipient D are 9-10 AM, 10-11 AM and 11-12 AM corresponding to the fixed geographical shipping areas of Beitou district, Zhongzheng district and Zhongshan district respectively. The available shipping time periods of the recipient E are 9-10 AM, 10-11 AM and 11-12 AM corresponding to the fixed geographical shipping areas of Beitou district, Zhongzheng district and Zhongshan district respectively.

The available shipping time periods of the recipient F are 8-9 AM, 10-11 AM and 11-12 AM corresponding to the fixed geographical shipping areas of Beitou district, Zhongshan district and Da'an district respectively. The available shipping time periods of the recipient G are 9-10 AM, 10-11 AM and 11-12 AM corresponding to the fixed geographical shipping areas of Zhongshan district, Zhongzheng district and Zhongshan district respectively. The available shipping time periods of the recipient H are 8-9 AM and 9-10 AM corresponding to the fixed geographical shipping areas of Beitou district and Zhongshan district respectively. The available shipping time periods of the recipient I are 8-9 AM, 9-10 AM and 11-12 AM corresponding to the fixed geographical shipping areas of Nangang district, Nangang district and Da'an district respectively. The available shipping time periods of the recipient J are 9-10 AM, 10-11 AM and 11-12 AM corresponding to the fixed geographical shipping areas of Zhongshan district, Zhongzheng district and Zhongshan district respectively.

In step 202, for the delivery time period 8-9 AM, the portion of the pieces of cargo-shipping data 103 that include the available shipping time period matching such a delivery time period are retrieved. Further, in step 203, a statistical analysis is performed on the fixed geographical shipping area of all the pieces of the cargo-shipping data 103 to determine a delivery geographical shipping area, wherein the delivery geographical shipping area is the fixed geographical shipping area that is included in most number of the pieces of the cargo-shipping data 103. In the present embodiment, the delivery method using the statistical analysis that selects the fixed geographical shipping area included in most number of the pieces of the cargo-shipping data 103 as the delivery geographical shipping area is following the principle of a greedy algorithm. More specifically, in each such selection stage, the most advantageous option under the current condition is selected.

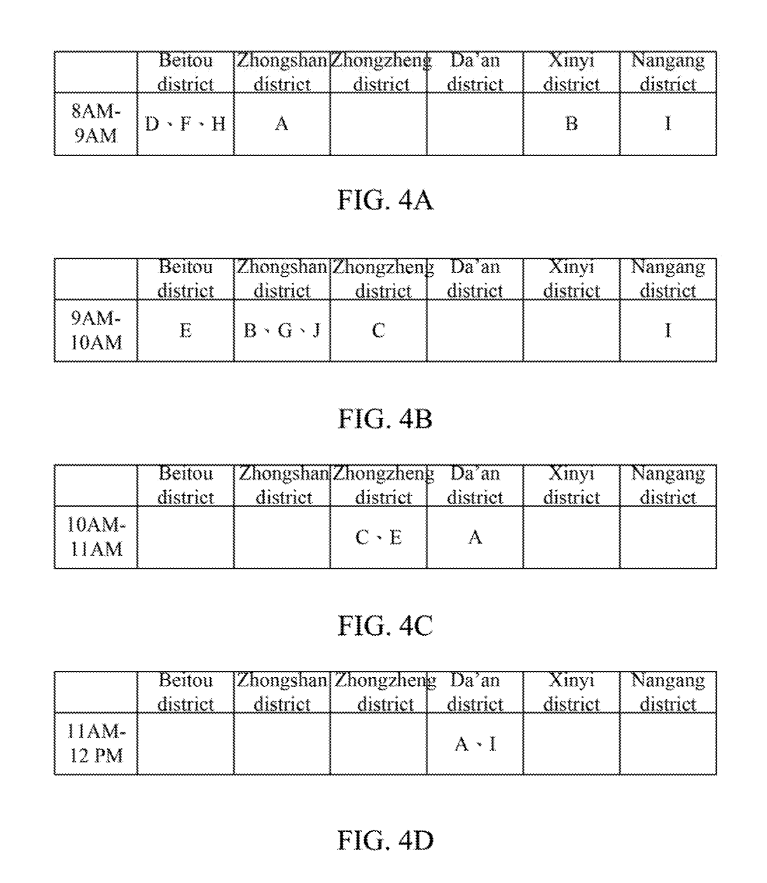

Reference is now made to FIGS. 4A-4D at the same time. FIGS. 4A-4D are diagrams illustrating each of the delivery time periods, each of the fixed geographical shipping areas and the corresponding recipients A-J in an embodiment of the present invention.

As illustrated in FIG. 4A, during the delivery time period of 8-9 AM, the pieces of the cargo-shipping data 103 that include Beitou district as the fixed geographical shipping area correspond to the recipients D, F and H. The piece of the cargo-shipping data 103 that includes Zhongshan district as the fixed geographical shipping area corresponds to the recipient A. The piece of the cargo-shipping data 103 that includes Xinyi district as the fixed geographical shipping area corresponds to the recipient B. The piece of the cargo-shipping data 103 that includes Nangang district as the fixed geographical shipping area corresponds to the recipient I.

As a result, the Beitou district that most number of the pieces of the cargo-shipping data 103 corresponds to for the delivery time period of 8-9 AM is selected to be the delivery geographical shipping area of the delivery time period of 8-9 AM.

In step 204, the instant positions 105 of the recipients D, F and H are retrieved according to the instant positioning information of each of the pieces of the cargo-shipping data 103, such as but not limited to the ID4, ID6 and ID8 illustrated in FIG. 3.

In step 205, a cargo delivery path 107 is determined according to the instant positions 105 of the pieces of the cargo-shipping data 103 that have the fixed geographical shipping area matching the current delivery geographical shipping area. In an embodiment, the cargo delivery path 107 is determined by the vehicle routing problem (VRP) algorithm or an approximate vehicle routing problem algorithm, such as but not limited to a cluster first-route second method, a route first-cluster second method, a saving or insertion or an improvement or exchanges based on the instant positions 105.

In step 206, whether the cargo delivery is finished is determined and the pieces of the delivered cargo-shipping data 103 are removed. For example, when the cargos of the cargo-shipping data 103 corresponding to the recipients D, F and H are delivered and indicated finishing by way such as D, F and H signing on a signature pad, these pieces of the cargo-shipping data 103 are removed and are not involved in the scheduling of the subsequent delivery time periods.

In an embodiment, the processing unit 106 can transmit a message through such as, but not limited to a network unit (not illustrated) to a user device of each of the recipients to notify the recipient of the shipping and receive receipt information from the user device of each of the recipients. Furthermore, the processing unit 106 removes the pieces of the cargo-shipping data 103 corresponding to the receipt information.

In step 207, whether the delivery time period is finished is determined. When there are still cargos that are to be delivered when the delivery time period is not finished, the flow goes back to step 206 to keep delivering the cargos.

When the delivery time period is finished, the flow goes to step 208 to determine whether all the delivery time periods are finished or all pieces of the cargo-shipping data 103 are removed.

Since not all the delivery time periods are finished and not all pieces of the cargo-shipping data 103 are removed, the flow goes back to step 202 to perform the steps 202-208 for the next deliver time period of 9-10 AM.

Since the pieces of the cargo-shipping data 103 of the recipients D, F and H are removed, in step 202, the other pieces of the cargo-shipping data 103 that correspond to the delivery time period of 9-10 AM are retrieved. As illustrated in FIG. 4B, the piece of the cargo-shipping data 103 that includes Beitou district as the fixed geographical shipping area corresponds to the recipient E. The pieces of the cargo-shipping data 103 that include Zhongshan district as the fixed geographical shipping area correspond to the recipients B, G and J. The piece of the cargo-shipping data 103 that includes Zhongzheng district as the fixed geographical shipping area corresponds to the recipient C. The piece of the cargo-shipping data 103 that includes Nangang district as the fixed geographical shipping area corresponds to the recipient I.

As a result, in step 203, the Zhongshan district that most number of the pieces of the cargo-shipping data 103 corresponds to for the delivery time period of 9-10 AM is selected to be the delivery geographical shipping area of the delivery time period of 9-10 AM. The delivery is performed in steps 204-206 with the pieces of the delivered cargo-shipping data 103 are removed upon receiving indication of successful delivery. Subsequently, since the delivery time period of 9-10 AM is determined to have ended in step 207 and not all the delivery time periods are finished and not all pieces of the cargo-shipping data 103 are removed are determined in step 208, the flow goes back to step 202 to perform the steps 202-208 for the next deliver time period of 10-11 AM.

Since the pieces of the cargo-shipping data 103 of the recipients B, G and J are removed, in step 202, the other pieces of the cargo-shipping data 103 that correspond to the delivery time period of 10-11 AM are retrieved. As illustrated in FIG. 4C, the pieces of the cargo-shipping data 103 that include Zhongzheng district as the fixed geographical shipping area correspond to the recipients C and E. The piece of the cargo-shipping data 103 that include Da'an district as the fixed geographical shipping area corresponds to the recipient A.

As a result, in step 203, the Zhongzheng district that most number of the pieces of the cargo-shipping data 103 corresponds to for the delivery time period of 10-11 AM is determined to be the delivery geographical shipping area of the delivery time period of 10-11 AM. The delivery is performed in steps 204-206 with the pieces of the delivered cargo-shipping data 103 are removed upon receiving indication of successful delivery. Subsequently, since the delivery time period of 10-11 AM is determined to have ended in step 207 and not all the delivery time periods are finished and not all pieces of the cargo-shipping data 103 are removed are determined in step 208, the flow goes back to step 202 to perform the steps 202-208 for the next deliver time period of 11 AM-12 PM.

Since the pieces of the cargo-shipping data 103 of the recipients C and E are removed, in step 202, the other pieces of the cargo-shipping data 103 that correspond to the delivery time period of 11 AM-12 PM are retrieved. As illustrated in FIG. 4D, the pieces of the cargo-shipping data 103 that include Da'an district as the fixed geographical shipping area correspond to the recipients A and I.

As a result, in step 203, the Da'an district that most number of the pieces of the cargo-shipping data 103 corresponds to for the delivery time period of 11 AM-12 PM is determined to be the delivery geographical shipping area of the delivery time period of 11 AM-12 PM. The delivery is performed in steps 204-206 with the pieces of the delivered cargo-shipping data 103 are removed upon receiving indication of successful delivery. Subsequently, since the delivery time period of 11 AM-12 PM is determined to have ended in step 207 and all the delivery time periods are finished and all pieces of the cargo-shipping data 103 are removed are determined in step 208, the flow goes back to step 209 to finish the flow of the cargo delivery scheduling method 200.

It is appreciated that in the above embodiments, the condition that all the cargo scheduled to be delivered can be successfully delivered within the delivery time period is used as the example. In an embodiment, when there are cargos not delivered yet when the delivery time period is finished, the corresponding pieces of the cargo-shipping data 103 are scheduled together with other pieces of the cargo-shipping data 103 in the next delivery time period.

In an embodiment, besides the available shipping time period and the shipping address corresponding to the available shipping time period of the recipient, each pieces of the cargo-shipping data 103 further includes a preference index. The cargo delivery scheduling method 200 in FIG. 2 can perform weighted statistical analyses on the fixed geographical shipping area of all the pieces of the cargo-shipping data 103 according to the preference index to determine the delivery geographical shipping area.

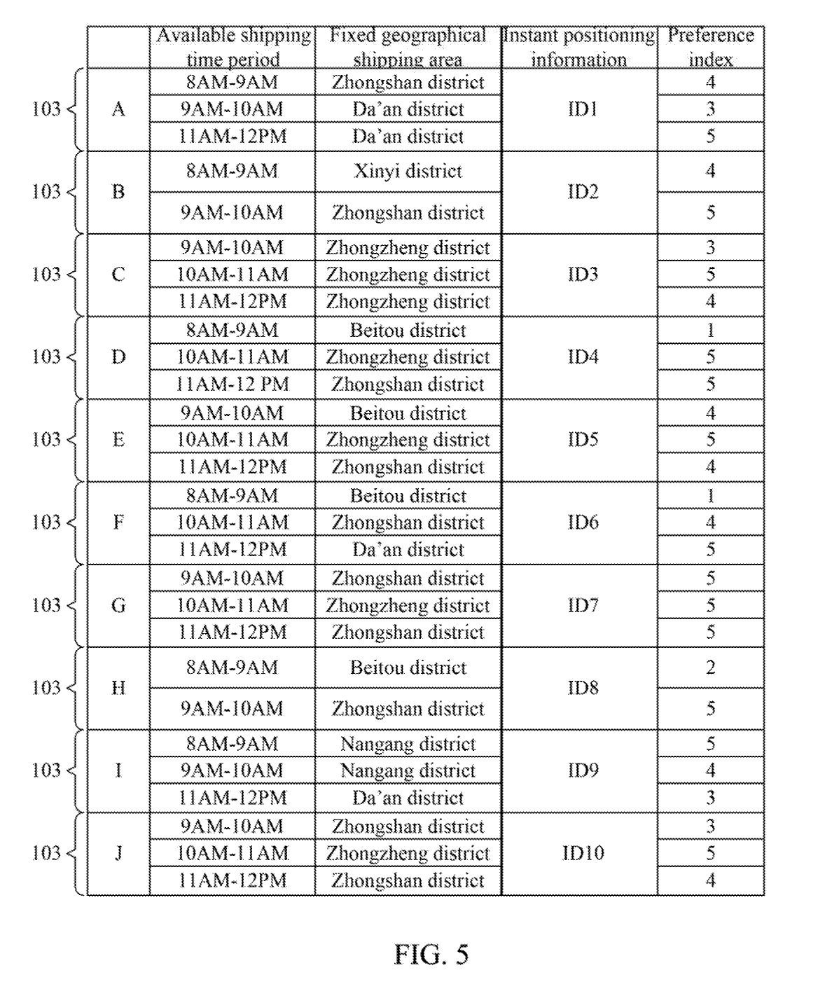

Reference is now made to FIG. 5. FIG. 5 is a diagram illustrating a plurality pieces of cargo-shipping data 103 in another embodiment of the present invention.

In FIG. 5, ten pieces of the cargo-shipping data 103 corresponding to ten recipients A-J are illustrated as entries of a table and the entries are mostly identical to the table in FIG. 3. As a result, the entries identical to those in FIG. 3 are not described in detail herein. In FIG. 5, each pieces of the cargo-shipping data 103 further includes the preference index corresponding to each of the available shipping time period. As a result, in step 203 of FIG. 2, weighted statistical analyses are performed on the fixed geographical shipping area of all the pieces of the cargo-shipping data 103 according to the preference index to determine the delivery geographical shipping area, wherein the delivery geographical shipping area is the fixed geographical shipping area that is included in most weighted number of the pieces of the cargo-shipping data 103. In the present embodiment, the delivery method using the weighted statistical analyses shat selects the fixed geographical shipping area included in most weighted number of the pieces of the cargo-shipping data 103 as the delivery geographical shipping area is equivalent to a greedy algorithm. More specifically, in each selection stage, the most advantageous option under the current condition is selected.

The method using the preference index to perform weighted statistical analyses is described in detail in the following paragraphs accompanied with FIG. 2.

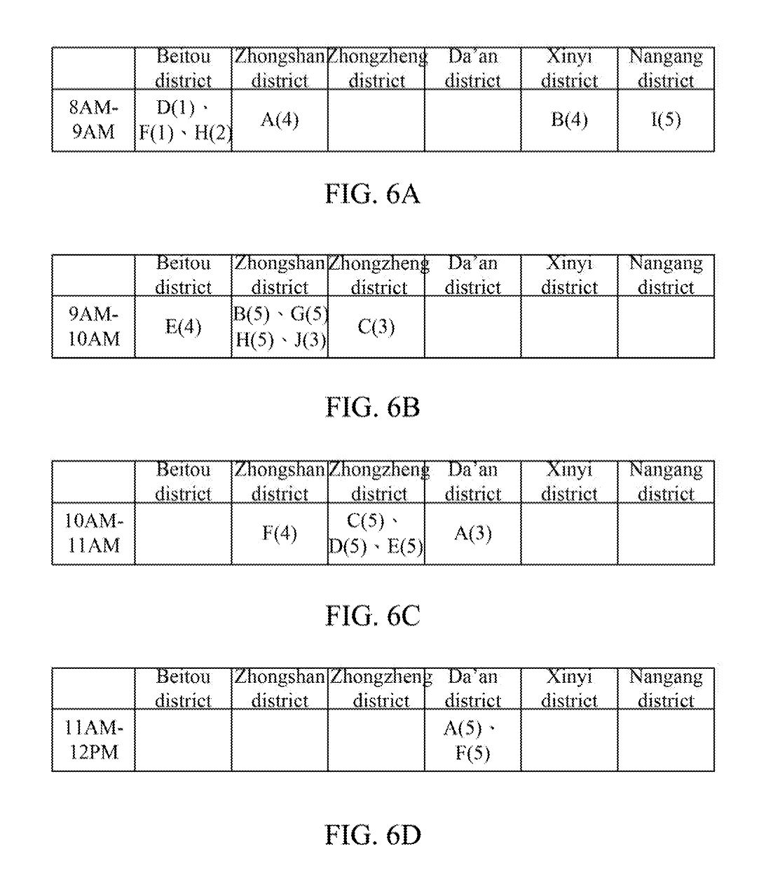

Reference is now made to FIGS. 6A-6D. FIGS. 6A-6D are diagrams illustrating each of the delivery time periods, each of the fixed geographical shipping areas, the corresponding recipients and the corresponding preference indexes in an embodiment of the present invention.

As illustrated in FIG. 6A, during the delivery time period of 8-9 AM, the pieces of the cargo-shipping data 103 that include Beitou district as the fixed geographical shipping area correspond to the recipients D, F and H and correspond to the preference indexes of 1, 1 and 2 respectively that sum up to 4. The piece of the cargo-shipping data 103 that includes Zhongshan district as the fixed geographical shipping area corresponds to the recipient A and corresponds to the preference index of 4. The piece of the cargo-shipping data 103 that includes Xinyi district as the fixed geographical shipping area corresponds to the recipient B and corresponds to the preference index of 4. The piece of the cargo-shipping data 103 that includes Nangang district as the fixed geographical shipping area corresponds to the recipient I and corresponds to the preference index of 5.

As a result, the Nangang district that most weighted number of the pieces of the cargo-shipping data 103 correspond to is determined to be the delivery geographical shipping area of the delivery time period of 8-9 AM. The delivery is performed in steps 204-206 with the pieces of the delivered cargo-shipping data 103 are removed upon receiving indication of successful delivery. Subsequently, since the delivery time period of 8-9 AM is determined to have ended in step 207 and not all the delivery time periods are finished and not all pieces of the cargo-shipping data 103 are removed are determined in step 208, the flow goes back to step 202 to perform the steps 202-208 for the next deliver time period of 9-10 AM.

Since the piece of the cargo-shipping data 103 of the recipient I is removed, in step 202, the other pieces of the cargo-shipping data 103 that correspond to the delivery time period of 9-10 AM are retrieved. As illustrated in FIG. 6B, the piece of the cargo-shipping data 103 that includes Beitou district as the fixed geographical shipping area corresponds to the recipient E and correspond to the preference index of 4. The pieces of the cargo-shipping data 103 that include Zhongshan district as the fixed geographical shipping area correspond to the recipients B, G, H and J and correspond to the preference indexes of 5, 5, 5 and 3 respectively that sum up to 18. The piece of the cargo-shipping data 103 that includes Zhongzheng district as the fixed geographical shipping area corresponds to the recipient C and correspond to the preference index of 3.

As a result, in step 203, the Zhongshan district that most number of the pieces of the cargo-shipping data 103 correspond to is determined to be the delivery geographical shipping area of the delivery time period of 9-10 AM. The delivery is performed in steps 204-206 with the pieces of the delivered cargo-shipping data 103 are removed upon receiving indication of successful delivery. Subsequently, since the delivery time period of 9-10 AM is determined to have ended in step 207 and not all the delivery time periods are finished and not all pieces of the cargo-shipping data 103 are removed are determined in step 208, the flow goes back to step 202 to perform the steps 202-208 for the next deliver time period of 10-11 AM.

Since the pieces of the cargo-shipping data 103 of the recipients B, G, H and J are removed, in step 202, the other pieces of the cargo-shipping data 103 that correspond to the delivery time period of 10-11 AM are retrieved. As illustrated in FIG. 6C, the piece of the cargo-shipping data 103 that includes Zhongshan district as the fixed geographical shipping area corresponds to the recipient F and correspond to the preference index of 4. The pieces of the cargo-shipping data 103 that include Zhongzheng district as the fixed geographical shipping area correspond to the recipients C, D and E and correspond to the preference indexes of 5, 5 and 5 respectively that sum up to 15. The piece of the cargo-shipping data 103 that includes Da'an district as the fixed geographical shipping area corresponds to the recipient A and correspond to the preference index of 3.

As a result, in step 203, the Zhongzheng district that most number of the pieces of the cargo-shipping data 103 correspond to is determined to be the delivery geographical shipping area of the delivery time period of 10-11 AM. The delivery is performed in steps 204-206 with the pieces of the delivered cargo-shipping data 103 are removed upon receiving indication of successful delivery. Subsequently, since the delivery time period of 10-11 AM is determined to have ended in step 207 and not all the delivery time periods are finished and not all pieces of the cargo-shipping data 103 are removed are determined in step 208, the flow goes back to step 202 to perform the steps 202-208 for the next deliver time period of 11-12 AM.

Since the pieces of the cargo-shipping data 103 of the recipients C, D and E are removed, in step 202, the other pieces of the cargo-shipping data 103 that correspond to the delivery time period of 11-12 AM are retrieved. As illustrated in FIG. 6D, the pieces of the cargo-shipping data 103 that include Da'an district as the fixed geographical shipping area correspond to the recipients A and F and correspond to the preference index of 5 and 5.

As a result, in step 203, the Da'an district that most number of the pieces of the cargo-shipping data 103 correspond to is determined to be the delivery geographical shipping area of the delivery time period of 11-12 AM. The delivery is performed in steps 204-206 with the pieces of the delivered cargo-shipping data 103 are removed upon receiving indication of successful delivery. Subsequently, since the delivery time period of 11-12 AM is determined to have ended in step 207 and all the delivery time periods are finished and all pieces of the cargo-shipping data 103 are removed are determined in step 208, the flow goes to step 209 to finish the flow of the cargo delivery scheduling method 200.

The cargo delivery scheduling method, device and non-transitory computer readable medium of the same can perform the statistical analyses on the fixed geographical shipping area of all the pieces of the cargo-shipping data to determine the delivery geographical shipping area for each of the delivery time periods. Further, the cargo delivery path is determined according to the instant positions of the cargo-shipping data corresponding to the selected geographical shipping area. As a result, by using the cargo delivery scheduling method, device and non-transitory computer readable medium of the same, not only the delivery time period matches the available time period of most of the recipients, but also the probability that the cargos are successfully delivered and the efficiency of cargo delivery are increased.

Although the present invention has been described in considerable detail with reference to certain embodiments thereof, they are not for purposes of limitation and other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cargo delivery scheduling method comprising:
(A) receiving a plurality pieces of cargo-shipping data each comprising at least one available shipping time period and at least one shipping address corresponding to the available shipping time period of the recipient, wherein the shipping address comprises a fixed geographical shipping area and an identifier pointing to the recipient's instant positioning information;
(B) for a delivery time period, retrieving the pieces of the cargo-shipping data having the available shipping time period matching the delivery time period;
(C) performing statistical analyses on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data;
(D) retrieving a first instant position according to the instant positioning information of each of the pieces of the cargo-shipping data that have the fixed geographical shipping area matching the delivery geographical shipping area;
(E) determining a cargo delivery path according to the first instant positions of the above pieces of the cargo-shipping data;
(F) determining whether the cargo is delivered and removing the pieces of the delivered cargo-shipping data; and
(G) when the delivery time period ends, performing steps (B) to (G) for the next delivery time period based on the remaining cargo-shipping data.

2. The cargo delivery scheduling method of claim 1, wherein each pieces of the cargo-shipping data further comprises an available waiting time corresponding to the available shipping time period, and the step (E) further comprises:
determining the cargo deliver path according to the first instant positions and the available waiting time of the pieces of the cargo-shipping data that have the fixed geographical shipping area matching the delivery geographical shipping area.

3. The cargo delivery scheduling method of claim 1, wherein each pieces of the cargo-shipping data further comprises a preference index corresponding to the available shipping time period, and the step (C) further comprises:
performing weighted statistical analyses on the fixed geographical shipping areas of all the pieces of the cargo-shipping data according to the preference indices to determine the delivery geographical shipping area, wherein the delivery geographical shipping area is the fixed geographical shipping area that is comprised in most weighted number on the preference indices of the pieces of the cargo-shipping data.

4. The cargo delivery scheduling method of claim 1, wherein the step (E) further comprises:
determining the cargo delivery path according to the first instant positions of the pieces of the cargo-shipping data based on a vehicle routing problem (VRP) algorithm or an approximate vehicle routing problem algorithm that includes a duster first-route second method, a route first-duster second method, a saving or insertion method or an improvement or exchanges method.

5. The cargo delivery scheduling method of claim 1, wherein the instant positioning information is a global navigation satellite system (GNSS) identification code.

6. The cargo delivery scheduling method of claim 1, wherein the fixed geographical shipping area is mapped by an address.

7. The cargo delivery scheduling method of claim 1, wherein the step (F) further comprises:
notifying a user device of the shipping and receiving a receipt information; and
removing the pieces of the cargo-shipping data corresponding to the receipt information.

8. The cargo delivery scheduling method of claim 1, further comprising a step (H):
determining whether all the delivery time periods are finished or all pieces of the cargo-shipping data are removed to end a flow of the cargo delivery scheduling method when all the delivery time periods are finished or all pieces of the cargo-shipping data are removed.

9. A cargo delivery scheduling device comprising:
an input unit;
an instant positioning unit;
a storage unit configured to store an application program; and
a processing unit electrically coupled to the input unit, the instant positioning unit and the storage unit and configured to execute the application program to perform a cargo delivery scheduling method, wherein the cargo delivery scheduling method comprises:
(A) receiving a plurality pieces of cargo-shipping data each comprising at least one available shipping time period and at least one shipping address corresponding to the available shipping time period of the recipient by using the input unit, wherein the shipping address comprises a fixed geographical shipping area and an identifier pointing to the recipient's instant positioning information;
(B) for a delivery time period, retrieving the pieces of the cargo-shipping data having the available shipping time period matching the delivery time period;
(C) performing statistical analyses on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data;
(D) retrieving, by using the instant positioning unit, a first instant position according to the instant positioning information of each of the pieces of the cargo-shipping data that have the fixed geographical shipping area matching the delivery geographical shipping area;
(E) determining a cargo delivery path according to the first instant positions of the above pieces of the cargo-shipping data;
(F) determining whether the cargo is delivered and removing the pieces of the delivered cargo-shipping data; and
(G) when the delivery time period ends, performing steps (B) to (G) for the next delivery time period based on the remaining cargo-shipping data.

10. The cargo delivery scheduling device of claim 9, wherein each pieces of the cargo-shipping data further comprises an available waiting time corresponding to the available shipping time period, and the step (E) further comprises:
determining the cargo deliver path according to the first instant positions and the available waiting time of the pieces of the cargo-shipping data that have the fixed geographical shipping area matching the delivery geographical shipping area.

11. The cargo delivery scheduling device of claim 9, wherein each pieces of the cargo-shipping data further comprises a preference index corresponding to the available shipping time period, and the step (C) further comprises:
performing weighted statistical analyses on the fixed geographical shipping areas of all the pieces of the cargo-shipping data according to the preference indices to determine the delivery geographical shipping area, wherein the delivery geographical shipping area is the fixed geographical shipping area that is comprised in most weighted number on the preference indices of the pieces of the cargo-shipping data.

12. The cargo delivery scheduling device of claim 9, wherein the step (E) further comprises:
determining the cargo delivery path according to the first instant positions of the pieces of the cargo-shipping data based on a vehicle routing problem (VRP) algorithm or an approximate vehicle routing problem algorithm that includes a duster first-route second method, a route first-duster second method, a saving or insertion method or an improvement or exchanges method.

13. The cargo delivery scheduling device of claim 9, wherein the instant positioning information is a global navigation satellite system identification code.

14. The cargo delivery scheduling device of claim 9, wherein the fixed geographical shipping area is mapped by an address.

15. The cargo delivery scheduling device of claim 9, wherein the step (F) further comprises:
notifying a user device of the shipping and receiving a receipt information; and
removing the pieces of the cargo-shipping data corresponding to the receipt information.

16. The cargo delivery scheduling device of claim 9, further comprising a step (H):
determining whether all the delivery time periods are finished or all pieces of the cargo-shipping data are removed to end a flow of the cargo delivery scheduling method when all the delivery time periods are finished or all pieces of the cargo-shipping data are removed.

17. A non-transitory computer readable medium that stores an application program to execute a cargo delivery scheduling method used in a cargo delivery scheduling device, wherein the cargo delivery scheduling method comprises:
(A) receiving a plurality pieces of cargo-shipping data each comprising at least one available shipping time period and at least one shipping address corresponding to the available shipping time period of the recipient, wherein the shipping address comprises a fixed geographical shipping area and an identifier pointing to the recipient's instant positioning information;
(B) for a delivery time period, retrieving the pieces of the cargo-shipping data having the available shipping time period matching the delivery time period;
(C) performing statistical analyses on the fixed geographical shipping areas of all the pieces of the cargo-shipping data to determine a delivery geographical shipping area, wherein the delivery geographical shipping area is the fixed geographical shipping area that is comprised in most number of the pieces of the cargo-shipping data;
(D) retrieving a first instant position according to the instant positioning information of each of the pieces of the cargo-shipping data that have the fixed geographical shipping area matching the delivery geographical shipping area;
(E) determining a cargo delivery path according to the first instant position of the above pieces of the cargo-shipping data;
(F) determining whether the cargo is delivered and removing the pieces of the delivered cargo-shipping data; and
(G) when the delivery time period ends, performing steps (B) to (G) for the next delivery time period based on the remaining cargo-shipping data.

18. The non-transitory computer readable medium of claim 17, wherein each pieces of the cargo-shipping data further comprises an available waiting time corresponding to the available shipping time period, and the step (E) further comprises:
determining the cargo deliver path according to the first instant positions and the available waiting time of the pieces of the cargo-shipping data that have the fixed geographical shipping area matching the delivery geographical shipping area.

19. The non-transitory computer readable medium of claim 17, wherein each pieces of the cargo-shipping data further comprises a preference index corresponding to the available shipping time period, and the step (C) further comprises:
performing weighted statistical analyses on the fixed geographical shipping areas of all the pieces of the cargo-shipping data according to the preference indices to determine the delivery geographical shipping area, wherein the delivery geographical shipping area is the fixed geographical shipping area that is comprised in most weighted number on the preference indices of the pieces of the cargo-shipping data.

20. The non-transitory computer readable medium of claim 17, wherein the fixed geographical shipping area is mapped by an address.
